(19) United States
(12) Patent Application Publication
(10) Pub. No.: US 2023/0230063 A1
(43) Pub. Date: Jul. 20, 2023

(54) SYSTEM AND METHOD FOR SELF CORRECTING ERRORS IN DATA RESOURCE TRANSFERS

(71) Applicant: BANK OF AMERICA CORPORATION, Charlotte, NC (US)

(72) Inventors: Venkatrao Meenavalli, Hyderabad (IN); Thomas Boffin James, Mumbai (IN); Amrut Gopal Nayak, Mumbai (IN)

(73) Assignee: BANK OF AMERICA CORPORATION, Charlotte, NC (US)

(21) Appl. No.: 17/578,076

(22) Filed: Jan. 18, 2022

(51) Int. Cl. G06Q 20/32

(52) U.S. Cl. CPC G06Q 20/325

(57) ABSTRACT

Embodiments of the invention are directed to systems, methods, and computer program products for intelligently identifying and correcting errors in resource transfer processes. The invention is generally comprised of a deployable layer of intelligent recommendation systems. The resulting service has ability to self-correct failed resource transfers. The invention is also dynamic, in that it can be integrated with other existing user interfaces. The intelligent recommendation systems are iteratively trained using feedback from real successes or failures in order to achieve a high degree of accuracy.

### FIELD

The present invention generally relates to the field of dynamic solutions for resource transfer error correction.

### BACKGROUND

With the increased use remote payment networks, there is a need for a system and methods which recognize, account for, and automate solutions for errors in resource transfer processing. Additionally, there may be instances where one or more third party systems are involved in a resource transfer, and an appropriate solution will dynamically respond to different resource transfer channels, and the needs or requirements of third party systems.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The systems and methods described herein address the above needs by providing an innovative solution for self-correcting errors in data resource transfers. The invention is generally comprised of a deployable layer of intelligent self-correction systems which include an intelligently trained model for resolution recommendation. The resulting service has ability to self-correct failed transactions and is also dynamic in that it can be integrated with other existing user interface systems. An artificial intelligence (AI) model captures details for each multiple resource transfers. The AI model, using deep learning, trains on a data set of test resource transfers until a high degree of accuracy is achieved. Results for ongoing resource transfers are then evaluated and the model is improved with up to date resource transfer details to ensure the AI model remains accurate. For certain failed resource transfers, the AI model looks for actions taken which were previously successful in resolving specific failures, such as authorization failures, communication failures, or the like. If no previous success for the same or similar cases can be located, the AI model applies deep learning to process the resource transfer details in order to ensure a certain degree of expected success above a given threshold count.

Embodiments of the invention relate to systems, methods, and computer program products for receiving or retrieving a data set for analysis, wherein the data set comprises multiple data files related to resource transfer successes, failures, and failure resolutions; utilizing the data set for iteratively training a deep learning model using a machine learning process, resulting in an intelligent recommendation model; receiving a user request for a purchase of one or more items; locating one or more merchants for the one or more items and automate a resource transfer for purchase of the one or more items; identifying a failure or partial failure of the resource transfer; and automatically initiating self-correction resource transfer action to rectify the failure or partial failure based on a generated recommendation from the intelligent recommendation model.

In some embodiments, the invention further comprises using the results of the self-correction resource transfer action to further iteratively train the deep learning model.

In some embodiments, locating one or more merchants for the one or more items further comprises locating two or more separate merchants for multiple items.

In some embodiments, automating the resource transfer further comprises requesting authorization for the resource transfer from the user as a collective transaction for all items; and conducting multiple transactions with the two or more separate merchants for the multiple items.

In some embodiments, the invention further comprises transmitting a notification to the user upon identifying the failure or partial failure of the resource transfer.

In some embodiments, the invention further comprises transmitting a notification to the user upon successfully rectifying the failure or partial failure based on the generated recommendation from the intelligent recommendation model.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a system environment for self-correcting errors in data resource transfers, in accordance with one embodiment of the present disclosure;

FIG. 2 is a block diagram illustrating components of the resource transfer system, in accordance with one embodiment of the present disclosure;

FIG. 3 is a block diagram illustrating a user device associated with the self correction system, in accordance with one embodiment of the present disclosure;

FIG. 4 is a flow diagram illustrating a process for training and execution of error self correction, in accordance with one embodiment of the present disclosure;

FIG. 5 is a graphical depiction illustrating a user submitted transfer request, in accordance with one embodiment of the present disclosure;

FIG. 6 is a graphical depiction illustrating a system notification of resource transfer error and self correction, in accordance with one embodiment of the present disclosure; and

FIG. 7 is a flow diagram illustrating a process for intelligent self correction of errors, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual associated with an entity. As such, in some embodiments, the user may be an individual having past relationships, current relationships or potential future relationships with an entity. In some instances, a “user” is an individual who has a relationship with the entity, such as a customer or a prospective customer. Accordingly, as used herein the term “user device” or “mobile device” may refer to mobile phones, personal computing devices, tablet computers, wearable devices, and/or any portable electronic device capable of receiving and/or storing data therein and are owned, operated, or managed by a user.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

The system allows for use of a machine learning engine to intelligently identify patterns in received resource transaction data. The machine learning engine may be used to analyze historical data in comparison to real-time received transaction data in order to identify transaction patterns or potential issues. The machine learning engine may also be used to generate intelligent aggregation of similar data based on metadata comparison resource transaction characteristics, which in some cases may be used to generate a database visualization of identified patterns similarities.

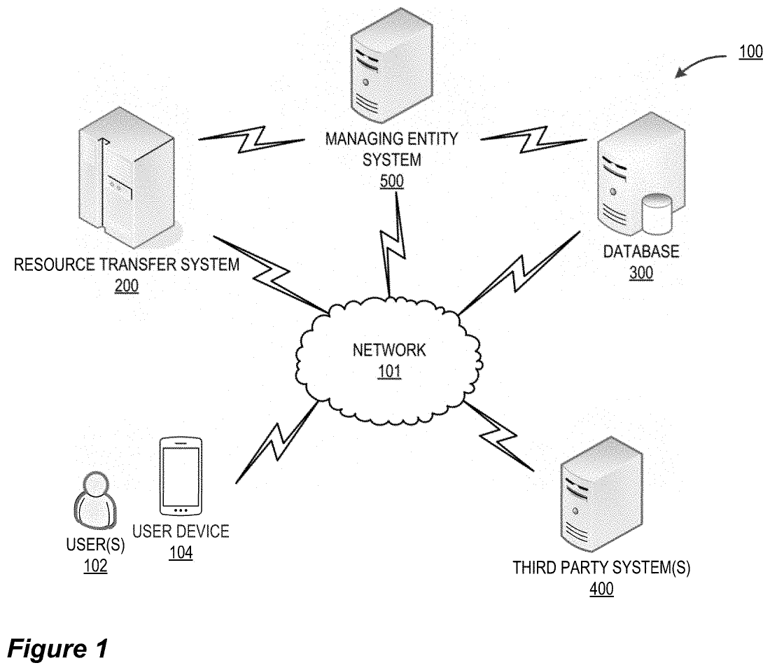

FIG. 1 illustrates an operating environment for self-correcting errors in data resource transfers, in accordance with one embodiment of the present disclosure. As illustrated, the operating environment 100 may comprise a user 102 and/or a user device 104 in operative communication with one or more third party systems 400 (e.g., web site hosts, registry systems, financial entities, third party entity systems, merchant systems, retailers, distributors, or the like). The operative communication may occur via a network 101 as depicted, or the user 102 may be physically present at a location separate from the various systems described, utilizing the systems remotely. The operating environment also includes a managing entity system 500, resource transfer system 200, a database 300, and/or other systems/devices not illustrated herein and connected via a network 101. As such, the user 102 may request information from or utilize the services of the resource transfer system 200, or the third party system 400 by establishing operative communication channels between the user device 104, the managing entity system 500, and the third party system 400 via a network 101.

Typically, the resource transfer system 200 and the database 300 are in operative communication with the managing entity system 500, via the network 101, which may be the internet, an intranet, or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the third party system 400). In this regard, the wireless communication channel may further comprise near field communication (NFC), communication via radio waves, communication through the internet, communication via electromagnetic waves and the like.

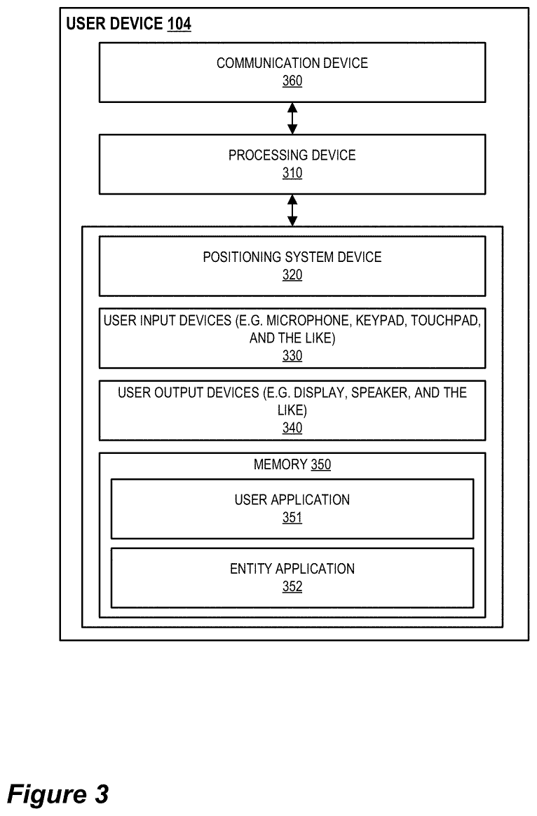

The user device 104 may comprise a mobile communication device, such as a cellular telecommunications device (e.g., a smart phone or mobile phone, or the like), a computing device such as a laptop computer, a personal digital assistant (PDA), a mobile internet accessing device, or other mobile device including, but not limited to portable digital assistants (PDAs), pagers, mobile televisions, laptop computers, cameras, video recorders, audio/video player, radio, GPS devices, any combination of the aforementioned, or the like. The user device is described in greater detail with respect to FIG. 3.

The managing entity system 500 may comprise a communication module and memory not illustrated, and may be configured to establish operative communication channels with a third party system 400 and/or a user device 104 via a network 101. The managing entity may comprise a data repository 256. The data repository 256 may contain resource account data, and may also contain user data. This user data may be used by the managing entity to authorize or validate the identity of the user 102 for accessing the system (e.g., via a username, password, biometric security mechanism, two-factor authentication mechanism, or the like). In some embodiments, the managing entity system is in operative communication with the resource transfer system 200 and database 300 via a private communication channel. The private communication channel may be via a network 101 or the resource transfer system 200 and database 300 may be fully integrated within the managing entity system 500, such as a virtual private network (VPN), or over a secure socket layer (SSL).

The managing entity system 500 may communicate with the resource transfer system 200 in order to transmit data associated with observed or received data from or via a plurality of third party systems 400. In some embodiments, the managing entity system 500 may utilize the features and functions of the resource transfer system 200 to initialize advisory measures in response to identifying data protection deficiencies. In other embodiments, the managing entity and/or the one or more third party systems 400 may utilize the resource transfer system 200 to react to identified trends, patterns, or potential issues.

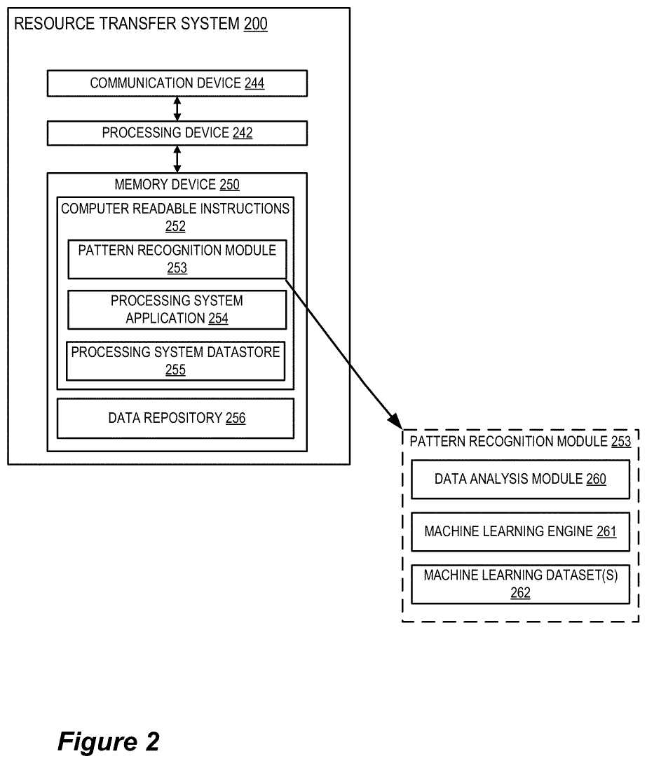

FIG. 2 illustrates a block diagram of the resource transfer system 200 associated with the operating environment 100, in accordance with embodiments of the present invention. As illustrated in FIG. 2, the resource transfer system 200 may include a communication device 244, a processing device 242, and a memory device 250 having a pattern recognition module 253, a processing system application 254 and a processing system datastore 255 stored therein. As shown, the processing device 242 is operatively connected to and is configured to control and cause the communication device 244, and the memory device 250 to perform one or more functions. In some embodiments, the pattern recognition module 253 and/or the processing system application 254 comprises computer readable instructions that when executed by the processing device 242 cause the processing device 242 to perform one or more functions and/or transmit control instructions to the database 300, the managing entity system 500, or the communication device 244. It will be understood that the pattern recognition module 253 or the processing system application 254 may be executable to initiate, perform, complete, and/or facilitate one or more portions of any embodiments described and/or contemplated herein. The pattern recognition module 253 may comprise executable instructions associated with data processing and analysis and may be embodied within the processing system application 254 in some instances. The resource transfer system 200 may be owned by, operated by and/or affiliated with the same managing entity that owns or operates the managing entity system 500. In some embodiments, the resource transfer system 200 is fully integrated within the managing entity system 500.

It is further understood that the resource transfer system 200 is also scalable, meaning the it relies on multi-nodal system for batch processing, data retrieval, reporting, or the like. As such, the resource transfer system 200 may be upgraded by adding or reducing the number of nodes active within the system in order to optimize efficiency and speed. In some embodiments, the multi-nodal nature of the system may also add to the integrity of the system output, where various machine learning models may be applied via different nodes on the same data set, and later analyzed against one another to determine a consensus or optimize the accuracy of data reporting. A multi-nodal approach also allows the resource transfer system 200 to be less vulnerable. For instance, each node may be schedule for maintenance at different intervals to avoid total system downtime, and each node may be taken offline in the event of a node failure without compromising access to the system's capabilities.

The pattern recognition module 253 may further comprise a data analysis module 260, a machine learning engine 261, and a machine learning dataset(s) 262. The data analysis module 260 may store instructions and/or data that may cause or enable the resource transfer system 200 to receive, store, and/or analyze data received by the managing entity system 500 or the database 300, as well as generate information and transmit responsive data to the managing entity system 500 in response to one or more requests or via a data stream between the resource transfer system 200 and the managing entity system 500. The data analysis module may pre-process data before it is fed to the machine learning engine 261. In this way, the resource transfer system 200 may exercise control over relevance or weighting of certain data features, which in some embodiments may be determined based on a metadata analysis of machine learning engine 261 output over time as time-dependent data is changed.

For instance, in some embodiments, the data analysis module may receive a number of data files containing metadata which identifies the files as originating from a specific source application, containing certain data fields, or signifying certain transaction types, merchants, sellers, users, or the like, and may package this data to be analyzed by the machine learning engine 261, as well as store the files in a catalog of data files in the data repository 256 or database 300 (e.g., files may be catalogued according to any metadata characteristic, including descriptive characteristics such as source, identity, content, data field types, or the like, or including data characteristics such as file type, size, encryption type, obfuscation, access rights, or the like). The machine learning engine 261 and machine learning dataset(s) 262 may store instructions and/or data that cause or enable the resource transfer system 200 to generate, based on received information, new output in the form of prediction, current status, analysis, or the like of one or more communications, network activity data streams, or data field patterns. In some embodiments, the machine learning engine 261 and machine learning dataset(s) 262 may store instructions and/or data that cause or enable the resource transfer system 200 to determine recommended actions for resolution of resource transfer failure or partial failure, determine access limitations or authorization privileges, or determine prophylactic actions to be taken to benefit one or more specific users or systems for their protection or privacy.

The machine learning dataset(s) 262 may contain data queried from database 300 or may be extracted or received from third party systems 400, managing entity system 500, or the like, via network 101. The database 300 may also contain metadata, which may be generated at the time of data creation, onboarding to the managing entity system 500 or resource transfer system 200, or in some cases may be generated specifically by the data analysis module 260. In some cases, the metadata may include statistics regarding the data fields in each data set, which may be stored in a separate tabular dataset and tracked over a certain temporal period, such as a day, month, multi-month period, or the like, in order to provide the capability for meta-analysis on how data features affect modeling over time.

In some embodiments, the machine learning dataset(s) 262 may also contain data relating to user activity or device information, which may be stored in a user account managed by the managing entity system. In some embodiments, the machine learning engine 261 may be a single-layer recurrent neural network (RNN) which utilizes sequential models to achieve results in audio and textual domains. Additionally, the machine learning engine 261 may serve an alternate or dual purpose of analyzing user resource account history, user preferences, user interests, user device activity history, or other user submitted or gathered data from managing entity system 500, third party system 400, or the like, in order to generate predictions as to the statistical certainty that certain resource transactions, user device behavior, user communications, or the like, is appropriate or will be successful. For instance, the machine learning engine may consist of a multilayer perceptron neural network, recurrent neural network, or a modular neural network designed to process input variables related to one or more user characteristics and output recommendations or predictions. Given the nature of the managing entity system 500, particularly in embodiments where the managing entity system 500 is a financial institution, the machine learning engine 261 may have a large dataset of user account information, resource transaction information, account resource amount information, communication information, merchant information, data on known patterns for resource transactions on multiple payment channels, or the like, from which to draw from and discern specific patterns or correlations in device behavior, network communications between devices, or the like. It is understood that such data may be anonymized or completely stripped of personal identifying characteristics of specific users in preferred embodiments, with no negative impact the system's ability to generate accurate output or prediction data given certain variables.

In further embodiments, the machine learning engine 261 may have one or more data sets containing user account information, user communication pattern information, resource transaction information, account resource amount information, account access information, user authorization information, situational data, user interaction information, or the like, from which to draw from and discern specific patterns or correlations related to account security, system security, or the like. For instance, the machine learning engine 261 may be trained on a large dataset of exemplary data in order to based its determinations on (e.g., the machine learning engine 261 may adapt over time to accurately and precisely identify data fields within data sets that contain accurate or necessary information for successful resource transfers, or the like). As such, it is imperative that the machine learning engine 261 operate in an accurate and predictable manner, and the model must have the capability to dynamically adapt over time in response to changing data characteristics. However, if one feature set of the incoming data stream is skewing the output of the machine learning engine 261, it is necessary for the system to discern if the skew is natural or otherwise perhaps an intentionally levied method against the system in order to train the model to react to patterns or characteristics in a certain way. In such situations, the analysis of metadata in conjunction with machine learning output in order to identify feature sets which have the highest degree of impact on machine learning output over time may be most crucial, and the machine learning mode may need to be adjusted accordingly.

The machine learning engine 261 may receive data from a plurality of sources and, using one or more machine learning algorithms, may generate one or more machine learning datasets 262. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. It is understood that additional or alternative machine learning algorithms may be used without departing from the invention.

The communication device 244 may generally include a modem, server, transceiver, and/or other devices for communicating with other devices on the network 101. The communication device 244 may be a communication interface having one or more communication devices configured to communicate with one or more other devices on the network 101, such as the resource transfer system 200, the user device 104, other processing systems, data systems, etc. Additionally, the processing device 242 may generally refer to a device or combination of devices having circuitry used for implementing the communication and/or logic functions of the resource transfer system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the resource transfer system 200 may be allocated between these processing devices according to their respective capabilities. The processing device 242 may further include functionality to operate one or more software programs based on computer-executable program code 252 thereof, which may be stored in a memory device 250, such as the processing system application 254 and the pattern recognition module 253. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the resource transfer system 200 may generally refer to a device or combination of devices that store one or more forms of computer-readable media for storing data and/or computer-executable program code/instructions. For example, the memory device 250 may include any computer memory that provides an actual or virtual space to temporarily, or permanently, store data and/or commands provided to the processing device 242 when it carries out its functions described herein.

FIG. 3 is a block diagram illustrating a user device associated with the self correction system, in accordance with one embodiment of the present disclosure. The user device 104 may include a user mobile device, desktop computer, laptop computer, or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, laptop computers, cameras, video recorders, audio/video player, radio, GPS devices, any combination of the aforementioned devices. The user device 104 may generally include a processing device or processor 310 communicably coupled to devices such as, a memory device 350, user output devices 340 (for example, a user display or a \speaker), user input devices 330 (such as a microphone, keypad, touchpad, touch screen, and the like), a communication device or network interface device 360, a positioning system device 320, such as a geo-positioning system device like a GPS device, an accelerometer, and the like, one or more chips, and the like.

The processor 310 may include functionality to operate one or more software programs or applications, which may be stored in the memory device 350. For example, the processor 310 may be capable of operating applications such as a user application 351, an entity application 352, or a web browser application. The user application 351 or the entity application may then allow the user device 104 to transmit and receive data and instructions to or from the third party system 400, resource transfer system 200, and the managing entity system 500, and display received information via the user interface of the user device 104. The user application 351 may further allow the user device 104 to transmit and receive data to or from the managing entity system 500 data and instructions to or from the resource transfer system 200, web content, such as, for example, location-based content and/or other web page content, according to a Wireless Application Protocol (WAP), Hypertext Transfer Protocol (HTTP), and/or the like. The user application 351 may allow the managing entity system 500 to present the user 102 with a plurality of recommendations, identified trends, suggestions, transaction data, pattern data, graph data, statistics, and/or the like for the user to review. In some embodiments, the user interface displayed via the user application 351 or entity application 352 may be entity specific. For instance, while the resource transfer system 200 may be accessed by multiple different entities, it may be configured to present information according to the preferences or overall common themes or branding of each entity system of third party system. In this way, each system accessing the resource transfer system 200 may use a unique aesthetic for the entity application 352 or user application 351 portal.

The processor 310 may be configured to use the communication device 360 to communicate with one or more devices on a network 101 such as, but not limited to the third party system 400, the resource transfer system 200, and the managing entity system 500. In this regard the processor 310 may be configured to provide signals to and receive signals from the communication device 360. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols and/or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 104 may also be configured to operate in accordance with non-cellular communication mechanisms, such as via a wireless local area network (WLAN) or other communication/data networks. The user device 104 may also be configured to operate in accordance Bluetooth® low energy, audio frequency, ultrasound frequency, or other communication/data networks.

The communication device 360 may also include a user activity interface presented in user output devices 340 in order to allow a user 102 to execute some or all of the processes described herein. The application interface may have the ability to connect to and communicate with an external data storage on a separate system within the network 101. The user output devices 340 may include a display (e.g., a liquid crystal display (LCD) or the like) and a speaker or other audio device, which are operatively coupled to the processor 310 and allow the user device to output generated audio received from the resource transfer system 200. The user input devices 330, which may allow the user device 104 to receive data from the user 102, may include any of a number of devices allowing the user device 104 to receive data from a user 102, such as a keypad, keyboard, touch-screen, touchpad, microphone, mouse, joystick, other pointer device, button, soft key, and/or other input device(s).

The user device 104 may also include a memory buffer, cache memory or temporary memory device 350 operatively coupled to the processor 310. Typically, one or more applications 351 and 352, are loaded into the temporarily memory during use. As used herein, memory may include any computer readable medium configured to store data, code, or other information. The memory device 350 may include volatile memory, such as volatile Random Access Memory (RAM) including a cache area for the temporary storage of data. The memory device 350 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the resource transfer system 200 performing one or more steps described herein in conjunction with other devices and systems, either automatically based on executing computer readable instructions of the memory device 250, or in response to receiving control instructions from the managing entity system 500. In some instances, the system refers to the devices and systems on the operating environment 100 of FIG. 1. The features and functions of various embodiments of the invention are be described below in further detail.

It is understood that the servers, systems, and devices described herein illustrate one embodiment of the invention. It is further understood that one or more of the servers, systems, and devices can be combined in other embodiments and still function in the same or similar way as the embodiments described herein.

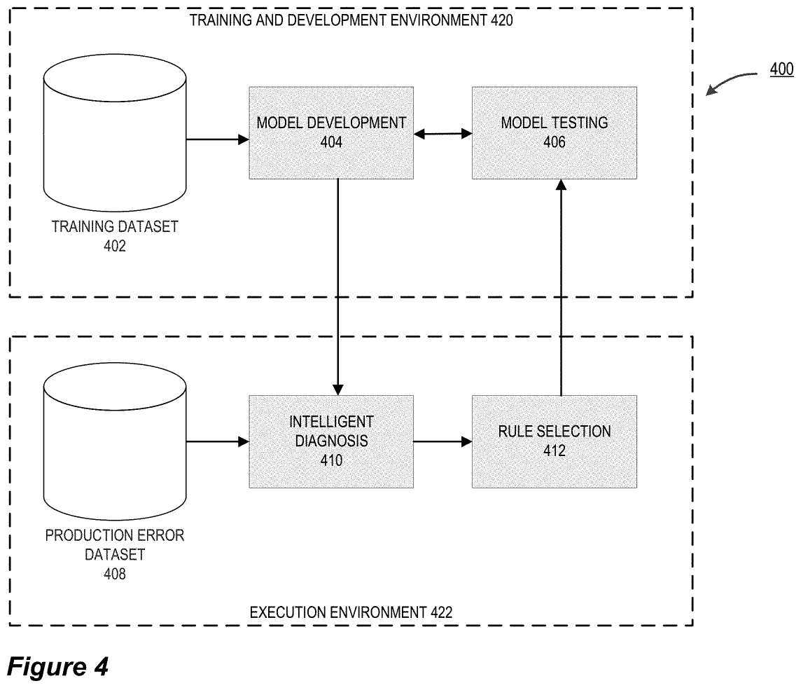

FIG. 4 is a flow diagram illustrating a process for training and execution of error self-correction, in accordance with one embodiment of the present disclosure. As shown, the system includes a training dataset 402, as well as a production error dataset 408. The training dataset 402 is utilized by a training and development environment 420 in order to develop, train, and test models for intelligent self-correction of resource transfer errors. The training dataset may be a store of historical data or synthetic data used to train machine learning engine 261 of resource transfer system 200. As such, the training dataset 402 may be considered at least a subset of machine learning dataset(s) 262. The training dataset 402 may contain a multitude of data regarding transactions which succeeded or failed for different reasons, as well as the steps necessary to resolve such errors. Over time, the machine learning engine 261 is trained during model development 404 in order to intelligently recognize and group similar transactions, contextualize situational data, and recommend solutions on an issue-by-issue basis for future failed transactions or authorizations, resulting in an intelligent recommendation model.

Developed models are used by the machine learning engine 261 for intelligent diagnosis 410 as new transaction data is provided via the production error dataset 408. The machine learning engine 404 will select a rule based on its training in order to attempt to automatically resolve the error, as indicated by rule selection 412. Model testing 406 indicates that the model development 404 is an ongoing process, as indicated by the two-way data flow between these processes. As rules are intelligently selected by deployed models, and applied to a number of different error types, the rule selection 412 process will feed information back to the model testing 406 process in order to evaluate their effectiveness and retrain the intelligent recommendation model. In this way the training and development environment 420 seamlessly interacts with the execution environment to iteratively improve the models over time as new situations arise or as the production error dataset grows. The resulting models are used by the machine learning engine 261 in order to accurately predict, identify, and resolve transaction or authorization errors in the production error dataset. Errors may include, for instance, software version upgrade requirements, server patching, network transfer errors, payment declines, user authentication failures, merchant authorization failures, incorrect payment information provided, item out of stock alerts, item backorder alerts, unavailable shipping methods or distribution channels, or the like.

As such, depending on the error, the rule selected may indicate that it would be appropriate to contact different parties, depending on the situation. In some embodiments, if the user has incorrectly entered their contact information, the intelligent recommendation model may compare the provided information to user information that the system has on file for the user. In some embodiments, the system may be pre-authorized to provide accurate information in the event of user error, or in the event that the user had previously authenticated themselves in one or more ways prior to the transaction. In this way, the system can stand-in for the user and provide accurate information and automatically retry the transaction to achieve success.

In other embodiments, the system may identify that the error is related to a merchant or distributor for a given product. In this situation, the rule selection 412 may indicate that the model should generate a message or request to the user, merchant, or distributor in order to prompt a resolution. In some embodiments, the intelligent recommendation model may have historical data from the same or similar merchant(s) indicating that the merchant, or network used by the merchant, is experiencing network slowdown, and the transaction may have timed-out. In this case, the system may intelligently re-authorize the transaction at a later time, or in incremental succession multiple times over a given time period until success is achieved. In some embodiments, the system may ask the user for authorization or confirmation for attempting such automated solutions. In other embodiments, the system may transmit a message to the merchant if a number of transactions are identified as failing with the particular merchant. The system may provide helpful contextual analysis for the merchant to find a solution, and may provide the merchant with a means of responding to the intelligent recommendation system when the transaction channel is operational again, allowing the system to choose an appropriate time to automatically re-try the transaction with a higher chance of success.

In still further embodiments, the system may recognize an error in the supply chain or distribution of a product, such as an out-of-stock error which prompted the transaction to fail, or for which the user should be notified about a change in shipping time, or the like. In these embodiments, the system may locate another merchant that uses a different distributor, or may contact the distributor directly to find an updated solution, or to obtain more detailed information as to when the user should expect the product. In some embodiments, the system may prompt the user and allow them to accept a failed transaction rather than automatically re-try the transaction with a different merchant, or automatically accept a later estimated shipping/delivery time. The system may take different actions depending on the product information associated with the transaction as well. For instance, if the user is ordering an item which is perishable, or selected expedited, urgent, or overnight shipping, or the like, the system may prioritize finding a different merchant over other solutions.

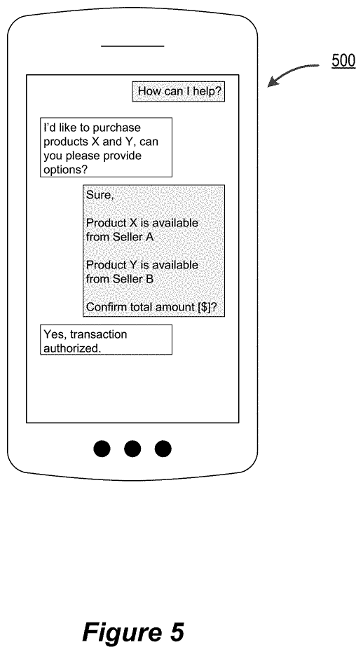

FIG. 5 is a graphical depiction illustrating a user submitted transfer request, in accordance with one embodiment of the present disclosure. As shown in FIG. 5, the user may utilize the user interface 500 of an application such as user application 351 or entity application 352 in order to interface with the resource transfer system 200 and receive feedback from the intelligent recommendation model. In the embodiment shown in FIG. 5, the user may use a text-based channel of communication to inquire about purchasing multiple products. The intelligent recommendation model can analyze the input from the user and generate a recommendation as to where products are available for sale, and may incorporate a best price, quickest shipping time, or the like, into the determination of the best offer, depending on user preferences or the content of the original user input.

In some embodiments, the user may inquire about multiple products at one time, such as product X and product Y, as shown in FIG. 5. In this instance, the intelligent recommendation model may locate two separate merchants, retailers, or sellers who sell each of product X and product Y, and may display a total aggregated purchase price for both products. In this way, the user may simply respond by authorizing the transaction for product X and product Y at the same time, and the resource transfer system 200 may complete each separate purchase on the user's behalf In this way, the user experience is simplified and streamlined to emulate a single purchase amount, and single purchase authorization, which is then bifurcated by the resource transfer system 200 to complete the purchase of each of product X and product Y from two separate merchants, retailers, sellers, or the like. In some embodiments, the user may configure a user account with the resource transfer system to “link” or have permissioned access to one or more online merchant accounts in order to make automated purchases. In other embodiments, the user may simply add a payment instrument managed by the same entity as the resource transfer system 200, or a third party, to be used by the resource transfer system 200 in the course of making automated purchases. In this regard, the user may have one or more preferred payment methods stored in their user account with the resource transfer system 200, and the resource transfer system 200 may be able to identify special offers, programs, or the like, which benefit the user at certain merchants or retailers. In some embodiments, the user may authorize the resource transfer system 200 to select an optimized payment method from a number of preferred payment methods.

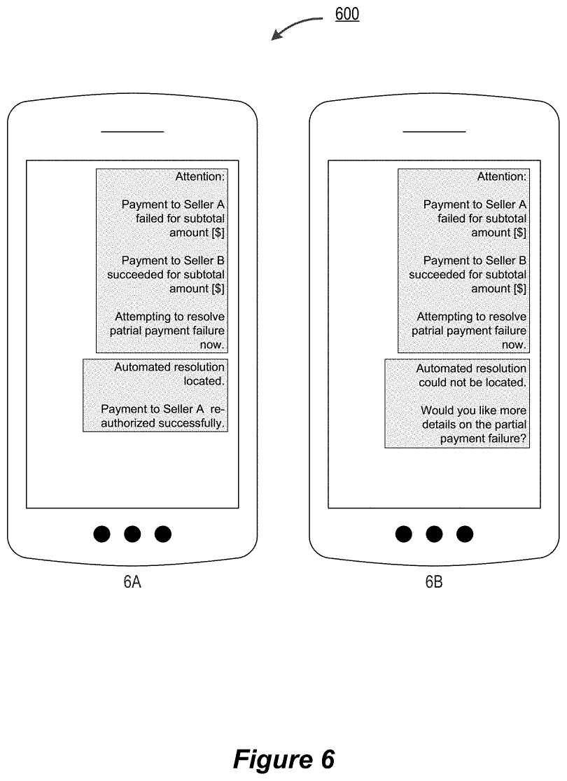

FIG. 6 is a graphical depiction illustrating a system notification of resource transfer error and self correction, in accordance with one embodiment of the present disclosure. As indicated by each separate graphic, 6A and 6B, the user interface 600 may differ depending on the success or failure of the intelligent recommendation model to locate an automated solution for a partial failed transaction. As stated with regard to FIG. 5, a single authorization from the user may prompt a back-end processing of two separate transactions for products from two separate sellers. It is understood that the invention is not limited to two transactions, but may include as many as necessary to meet the request of the user's input or inquiry about certain products. In the event that one or more of the back-end transactions fails, for any reason, the system may notify the user of the failure immediately and indicate that the system is attempting to intelligently and automatically resolve the partial payment failure. While this may not be necessary in every instance, it provides the user with some assurance that duplicate pending resource transfers showing on their account may indicate a failed transaction and a subsequent successful payment authorization, as opposed to a duplicate deduction from their account or available line of resources.

In the embodiment shown in 6A, the user interface 600 may indicate that the partial payment failure has been authorized successfully due to an appropriate automated resolution being located. The automated solution may take a number of different forms depending on the identified failure and level of authorization provided by the user for the system to act on their behalf. For instance, in configuring their user account, the user may authorize the intelligent recommendation model of the resource transfer system 200 to provide stored user credentials, such as name, address, or the like, in the event that the user may have entered these incorrectly on a linked merchant account. In other embodiments, the failure may be related to an issue with a particular payment network or preferred resource instrument, in which case the resource transfer system 200 may intelligently try a different preferred resource instrument that the user has authorized in their user account associated with the resource transfer system 200. In still further embodiments, the resource transfer system 200 may identify that the failure is merchant-specific, and may analyze other transactions occurring with the merchant from the resource transfer system 200 over time in order to identify when the merchant payment system is back online. For instance, in some embodiments, a second user could have authorized payment to the same merchant some period of time later than the original user, and the payment may have been transferred and processed successfully. As soon as the resource transfer system 200 recognizes that the merchant is again processing payments successfully, it may automatically re-initiate a queue of recent failed payments. In this way, the resource transfer system 200 may be situated uniquely to crowd-source data from a large number of transactions in order to identify when merchant-side issues arise and have been resolved, and this may benefit all users of the resource transfer system 200.

In still further embodiments, such as the embodiment shown in 6B, the user interface 600 may include a notification that an automated solution could not be located at the present time. In this case, the resource transfer system 200 may prompt the user with a question or preference as to whether they would like to receive more details about the payment failure. In some embodiments, if the user responds with a request for more information, the system may provide details as to the automated solutions attempted, and ruled out as potential causes of the failure, or may simply provide a link, contact information, order number, or the like, to the user in order that they can reach out to the merchant themselves and resolve the issue with customer service of the merchant.

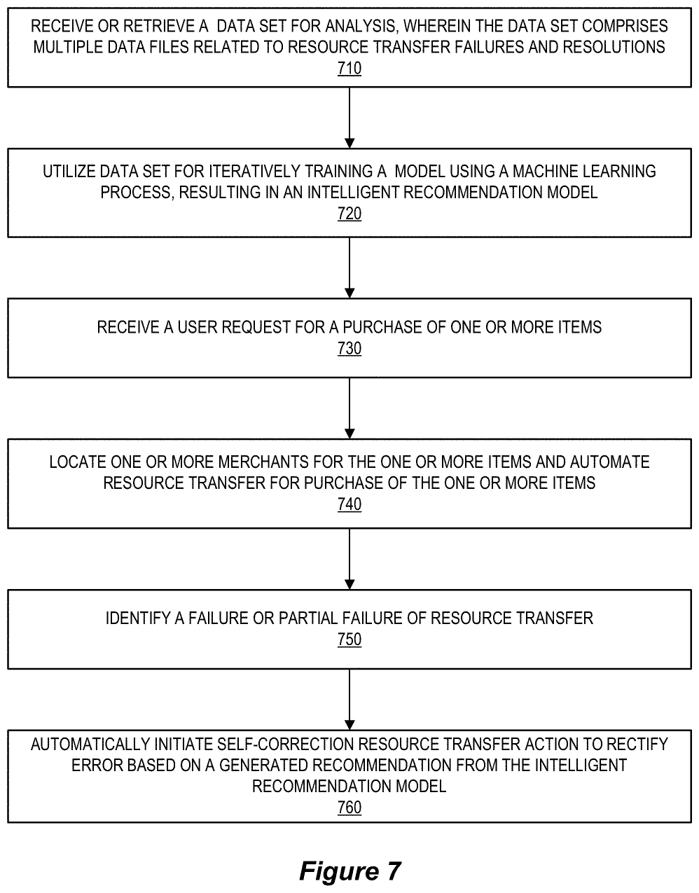

FIG. 7 is a flow diagram illustrating a process for intelligent self correction of errors, in accordance with one embodiment of the present disclosure. As shown in block 710, the process begins wherein the system receives a data set or retrieves the data set from storage for analysis. It is understood that the system may handle data sets containing multiple data files in any number of formats from any number of existing applications or datastores, including data files in both structured and unstructured formats. The data may be related to various resource transfer failures and associated resolutions taken to rectify the failures. The data may also include user communications, customer support communications, network environment data, merchant identifications, payment rail information, account numbers, or the like.

In this way, the system may interact with one or more entity systems 500, third party systems 400, or the like, and the various applications and associated data formats thereon. For example, in some embodiments, the system may receive data files in an unstructured format such as data typed in by a user in a chat window, terminal window, comment box, description field, or the like, such as in the instance of a user acting in a customer support capacity, as a customer onboarding assistant, or the like (e.g., the user may be interacting with one or more customers via a text-based chat function, or may be recording notes during an interaction with the customer, or the like). In other embodiments, the system may receive or record data in a structured format, such as via a relational database management system (RDMS), structured form document with pre-programmed information fields, spreadsheet, or the like (e.g., a user may fill out a user data configuration including their basic contact information, resource account information, user preferences, application authorizations, or the like).

The initial step in analyzing received data set is determining a data type and format and performing a first pass metadata scan of the data files in the data set to various information about the data files. For instance, the system may determine the application that created or uses the data files (“associated application”), storage location of the data files, storage method of the data files (encrypted, unencrypted, obfuscated, partially obfuscated, tokenized, or the like), and the current classification status of the data files or data within the data files (e.g., the data files may be classified as sensitive or private data, and may carry permissioned or role-based access privileges wherein only certain users or types of user may access the data within the files, or the like). The structure and format of the data files may inform the process of analyzing the information in some embodiments. For instance, the data analysis module 260 may perform an initial first pass scan of the metadata of the received data and determine a particular file format for the data, form structure of the data (customer form or customer application, or the like), and determine that a deep scan of the received data should be performed by the machine learning engine 261 according to that known format or structure in order to expedite the process. By using a multi-step approach to scanning received data, the system is able to intelligently optimize the efficiency of the analysis of received information by anticipating the nature of the structure, format, order, or substance expected within the received data ahead of time.

As shown in block 720, the process continues by utilizing the data set for iteratively training a model using a machine learning process, as described with regard to the machine learning engine 261 of the resource transfer system 200. This results in an intelligent recommendation model which can receive data from the production error dataset 408 in order to analyze real-time payment failures. Next, as shown in block 730, the system receives a user request for a purchase of one or more items. As discussed, and shown with regard to FIGS. 5 and 6, the system may respond with one or more options to purchase the requested items, and in some embodiments, the system may organize a series of purchases under one authorization from the user. As shown in block 740, the system may then locate one or more merchants for the one or more items and automate a resource transfer for purchase of the one or more items, wherein the resource transfer for purchase of the one or more items may comprise one or more resource transfer process aggregated under one total amount shown to the user and authorized by the user for the total number of items or products requested.

As shown in block 750, the process proceeds by identifying a failure or partial failure of the resource transfer for purchase of the one or more items. This may include a number of different issues or failures that occurred during the process of authorizing or executing a transfer of resources, including a network error, an information error, an account error, a merchant system error, or the like. The system may then automatically initiate a self-correction resource transfer action to rectify the identified error based on a generated recommendation from the intelligent recommendation model, as indicated in block 760.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined, or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for self-correcting data errors in resource transfers, the system comprising:
a memory device; and
a processing device operatively coupled to the memory device, wherein the processing device is configured to execute computer-readable program code to:
receive or retrieve a data set for analysis, wherein the data set comprises multiple data files related to resource transfer successes, failures, and failure resolutions;
utilize the data set for iteratively training a deep learning model using a machine learning process, resulting in an intelligent recommendation model;
receive a user request for a purchase of one or more items;
locate one or more merchants for the one or more items and automate a resource transfer for purchase of the one or more items;
identify a failure or partial failure of the resource transfer and a specific error;
determine that the specific error indicates a user authentication failure;
based on the specific error, transmit a notification to a user upon identifying the failure or partial failure of the resource transfer; and
automatically initiate self-correction resource transfer action to rectify the failure or partial failure based on a generated recommendation from the intelligent recommendation model.

2. The system of claim 1, further comprising using results of the self-correction resource transfer action to further iteratively train the deep learning model.

3. The system of claim 1, wherein locating the one or more merchants for the one or more items further comprises locating two or more separate merchants for multiple items.

4. The system of claim 3, wherein automating the resource transfer further comprises requesting authorization for the resource transfer from the user as a collective transaction for all items; and
conducting multiple transactions with the two or more separate merchants for the multiple items.

5. (canceled)

6. The system of claim 1, further comprising transmitting a notification to the user upon successfully rectifying the failure or partial failure based on the generated recommendation from the intelligent recommendation model.

7. The system of claim 1, wherein a partial failure further comprises failure of one of a group of transactions.

8. A computer program product for self-correcting data errors in resource transfers, the computer program product comprising a non-transitory computer-readable medium comprising code causing a first apparatus to:
receive or retrieve a data set for analysis, wherein the data set comprises multiple data files related to resource transfer successes, failures, and failure resolutions;
utilize the data set for iteratively training a deep learning model using a machine learning process, resulting in an intelligent recommendation model;
receive a user request for a purchase of one or more items;
locate one or more merchants for the one or more items and automate a resource transfer for purchase of the one or more items;
identify a failure or partial failure of the resource transfer and a specific error;
determine that the specific error indicates a user authentication failure;
based on the specific error, transmit a notification to a user upon identifying the failure or partial failure of the resource transfer; and
automatically initiate self-correction resource transfer action to rectify the failure or partial failure based on a generated recommendation from the intelligent recommendation model.

9. The computer program product of claim 8, further comprising using results of the self-correction resource transfer action to further iteratively train the deep learning model.

10. The computer program product of claim 8, wherein locating the one or more merchants for the one or more items further comprises locating two or more separate merchants for multiple items.

11. The computer program product of claim 10, wherein automating the resource transfer further comprises requesting authorization for the resource transfer from the user as a collective transaction for all items; and
conducting multiple transactions with the two or more separate merchants for the multiple items.

12. (canceled)

13. The computer program product of claim 8, further comprising transmitting a notification to the user upon successfully rectifying the failure or partial failure based on the generated recommendation from the intelligent recommendation model.

14. The computer program product of claim 8, wherein a partial failure further comprises failure of one of a group of transactions.

15. A computer-implemented method for self-correcting data errors in resource transfers, the method comprising:
receiving or retrieving a data set for analysis, wherein the data set comprises multiple data files related to resource transfer successes, failures, and failure resolutions;
utilizing the data set for iteratively training a deep learning model using a machine learning process, resulting in an intelligent recommendation model;
receiving a user request for a purchase of one or more items;
locating one or more merchants for the one or more items and automate a resource transfer for purchase of the one or more items;
identifying a failure or partial failure of the resource transfer and a specific error;
determining that the specific error indicates a user authentication failure;
based on the specific error, transmitting a notification to a user upon identifying the failure or partial failure of the resource transfer; and
automatically initiating self-correction resource transfer action to rectify the failure or partial failure based on a generated recommendation from the intelligent recommendation model.

16. The computer-implemented method of claim 15, further comprising using results of the self-correction resource transfer action to further iteratively train the deep learning model.

17. The computer-implemented method of claim 15, wherein locating the one or more merchants for the one or more items further comprises locating two or more separate merchants for multiple items.

18. The computer-implemented method of claim 17, wherein automating the resource transfer further comprises requesting authorization for the resource transfer from the user as a collective transaction for all items; and
conducting multiple transactions with the two or more separate merchants for the multiple items.

19. (canceled)

20. The computer-implemented method of claim 15, further comprising transmitting a notification to the user upon successfully rectifying the failure or partial failure based on the generated recommendation from the intelligent recommendation model.
